(19) United States
(12) Patent Application Publication
(10) Pub. No.: US 2008/0230656 A1
(43) Pub. Date: Sep. 25, 2008

(54) Aircraft wings having hinged vanes and aircraft having said wings

(76) Inventor: Moshe Kretchmer, Spring Valley, NY (US)

Correspondence Address: Byrne Poh LLP, 11 Broadway, Ste 865, New York, NY, 10004, US

(21) Appl. No.: 11/638,719

(22) Filed: Dec. 14, 2006

Related U.S. Application Data
(60) Provisional application No. 60/791,141, filed on Apr. 11, 2006.

(51) Int. Cl. B64C 27/28

(52) U.S. Cl. 244/7 R

(57) ABSTRACT

Reconfigurable aircraft wings with at least one set of hinged upper and lower vanes and aircraft that are equipped with such wings are provided. When the aircraft are taking off or landing vertically, the hinged vanes are open in order to allow rotor thrust to go through the wings, thereby permitting main rotors to be located above the wings. When the aircraft reach certain airspeeds, the hinged vanes are closed in order to provide normal lift of a fixed wing. The aircraft thereby take advantages of the helicopter and the traditional airplane with a fixed wing.

### CROSS REFERENCE TO RELATED APPLICATION

This application claims the benefit of U.S. Provisional Patent Application No. 60/791141, filed Apr. 11, 2006, which is hereby incorporated by reference herein in its entirety.

### FIELD OF THE INVENTION

The present invention relates to aircraft and aircraft wings. More particularly, the present invention relates to aircraft that combine the advantages of a helicopter and an airplane, and aircraft wings that enable the flight of the aforementioned aircraft by changing configuration based on the aircraft's motion.

### BACKGROUND OF THE INVENTION

Shortly after the airplane was invented, its disadvantage of requirement of the runway for takeoff and landing was quickly noticed; the requirement significantly limits the airplane's utility. The helicopter was introduced afterward in order to overcome the limitation of the airplane. The helicopter can take off and land in a relatively small area because it can direct all its thrust vertically. Despite the advantage, however, the helicopter's utility is limited because, among other limitations, the helicopter flies too slowly. The airplane, on the other hand, can fly at higher cruising speeds because it can direct all its thrust to produce forward speed; this, in turn, is possible because the airplane's fixed wing can provide vertical lift.

A main barrier to combining the advantages of the airplane and the helicopter is that the airplane's fixed wing obstructs the helicopter rotor's downward thrust. Aircraft manufacturers have attempted to combine the advantages, but have met with only limited successes. In order to overcome the barrier, for instance, the aircraft manufacturers have attempted to construct aircraft with rotors that are not located above wings. Such construction, however, produced highly unstable aircraft because the rotors are not placed above the aircraft's center of gravity. The Bell Boeing V-22 Osprey, for example, suffers from relatively high accident rates mainly because its two rotors are not located above its center of gravity.

### SUMMARY OF THE INVENTION

Reconfigurable aircraft wings with at least one set of hinged upper and lower vanes and aircraft that are equipped with such wings are provided. When the aircraft are taking off or landing vertically, the hinged vanes are open in order to allow rotor thrust to go through the wings, thereby permitting main rotors to be located above the wings. When the aircraft reach certain airspeeds, the hinged vanes are closed in order to provide normal lift of a fixed wing. In a preferred embodiment of the invention, the rear side of the upper and lower vanes is hinged to one another using one or more connecting rods, and tabs similar to trim tabs are used to aid the vanes to move up naturally to the closed position.

### BRIEF DESCRIPTION OF THE DRAWINGS

The present invention is described in detail below with reference to the attached drawing figures, wherein:

FIG. 1 illustrates a reconfigurable aircraft wing having hinged upper and lower vanes when the vanes are closed in accordance with some embodiments of the present invention;

FIG. 2 illustrates a reconfigurable aircraft wing having hinged upper and lower vanes when the vanes are open in accordance with some embodiments of the present invention;

FIG. 3 shows a detailed illustration of hinged upper and lower vanes in accordance with some embodiments of the present invention;

FIGS. 4A-C illustrate hinged upper and lower vanes in different positions in accordance with some embodiments of the present invention;

FIGS. 5A-B illustrate set of upper and lower vanes hinged at the front side of the vanes along the leading edge of a reconfigurable aircraft wing in accordance with some embodiments of the present invention;

FIGS. 6A-B illustrate a set of upper and lower vanes hinged at the front side of the vanes to a rib of a reconfigurable aircraft wing near a movable flap in accordance with some embodiments of the present invention;

FIG. 7 illustrates an aircraft that is equipped with a reconfigurable wing having hinged upper and lower vanes in accordance with some embodiments of the present invention; and

FIGS. 8A-C illustrate a hybrid aircraft having the reconfigurable wing that can change the position of its main rotor in accordance with some embodiments of the present invention.

### DETAILED DESCRIPTION OF THE PREFERRED EMBODIMENTS

As one skilled in the art will appreciate, the present invention includes aircraft wings that are configured to change shapes and aircraft that are equipped with and configured to take the advantage of the wings. Such aircraft can combine the advantages of the helicopter to take off and land within the confines of a small area and of the airplane with a fixed wing to fly at higher cruising speeds.

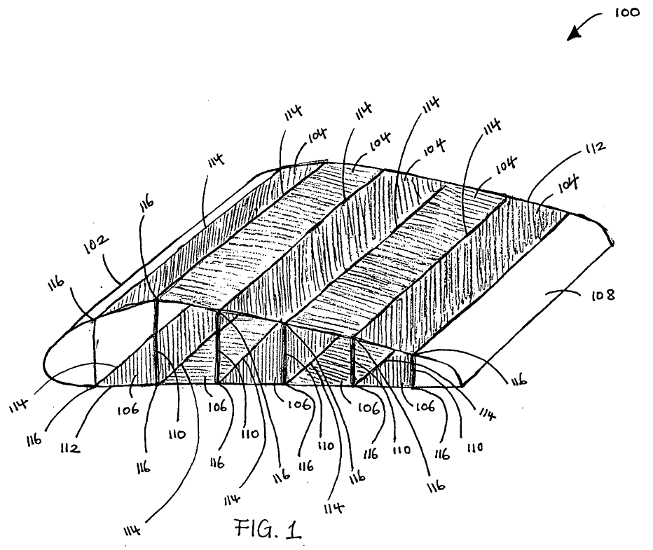

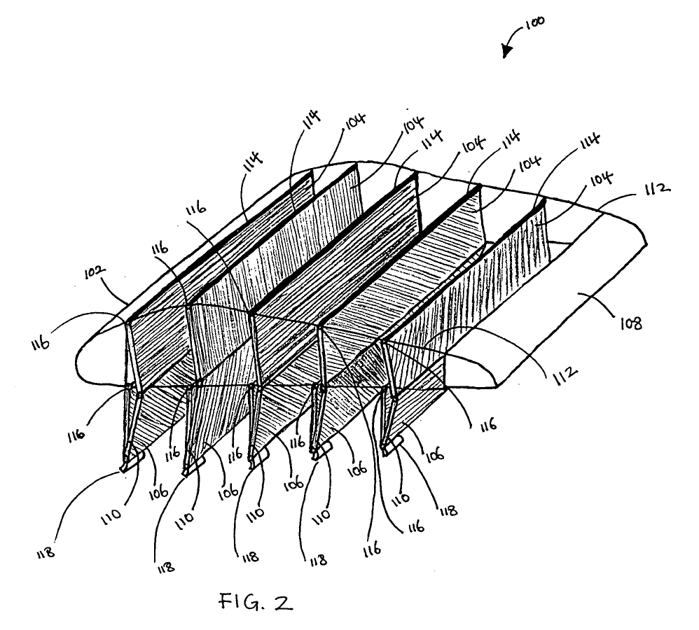

FIG. 1 illustrates a reconfigurable aircraft wing 100 having hinged upper and lower vanes 104, 106 when the vanes are closed in accordance with some embodiments of the present invention. FIG. 2 illustrates wing 100 when vanes 104, 106 are open. Wing 100 is constructed using spars 112 and ribs 114 and includes a leading edge 102, a movable flap 108, upper vanes 104, lower vanes 106, connecting rods 110, hinges 116, and tabs 118, which are similar to trim tabs. In some embodiments, vanes 104, 106 may be present for only a part, such as a rotor's wash part, of wing 100. In some other embodiments, a wing may be constructed by coupling two or more wing parts that are similar in construction to wing 100.

When vanes 104, 106 are closed, as shown in FIG. 1, the top of upper vanes 104 becomes the upper skin of wing 100 and the bottom of lower vanes 106 becomes the lower skin of wing 100. Wing 100 can also function as a fixed airplane wing that can provide vertical lift when vanes 104, 106 are closed. When vanes 104, 106 are open, as shown in FIG. 2, vanes 104, 106 collapse and become very slim, thereby allowing rotor thrust to wash downward through wing 100.

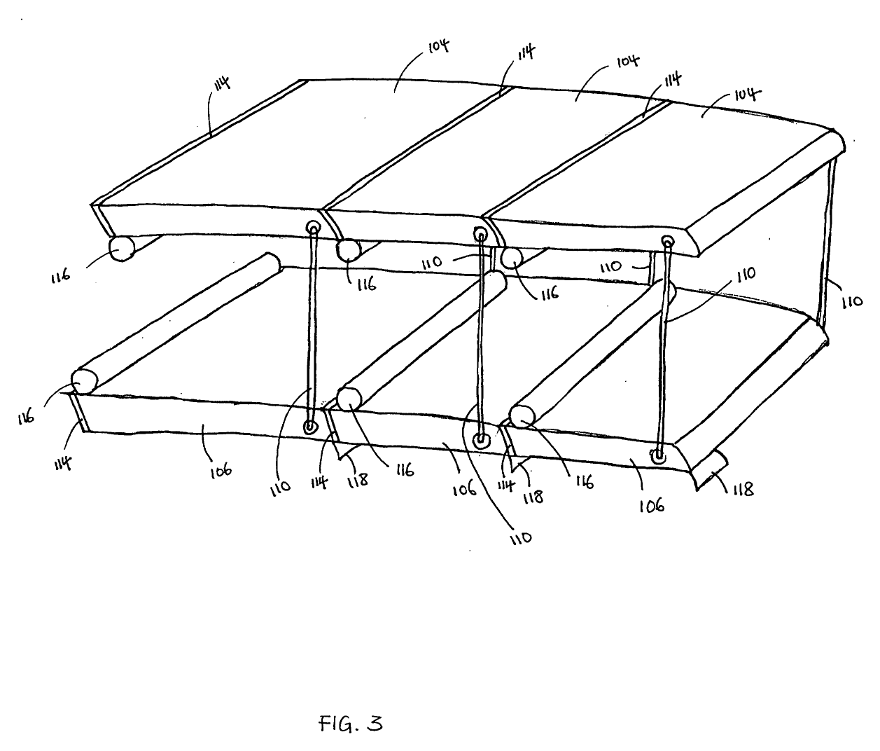

FIG. 3 shows a detailed illustration of upper vanes 104 and lower vanes 106 in accordance with some embodiments of the present invention. Upper and lower vanes 104, 106 are hinged along ribs 114 using hinges 116, which are coupled to the front side of vanes 104, 106. Tabs 118 are, in some embodiments, coupled to the rear end of lower vanes 106. In some embodiments, upper vanes 104 and lower vanes 106 are hinged to one another via connecting rods 110.

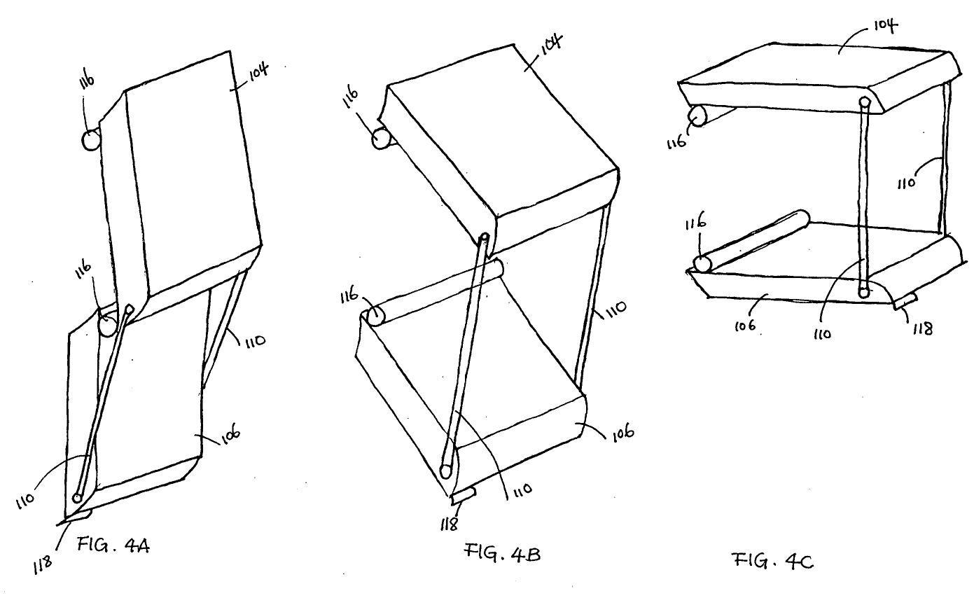

FIG. 4A illustrates hinged upper and lower vanes 104, 106 when vanes 104, 106 are open. FIG. 4B illustrates vanes 104, 106 when vanes 104, 106 are partially open while they are in transition from the open position to the closed position. When, for example, air pressure is applied to tabs 118 due to certain forward airspeeds, vanes 104, 106 may be caused to move naturally to the closed position. FIG. 4C illustrates vanes 104, 106 when vanes 104, 106 are closed. In some embodiments, tabs 118 are also designed to prevent vanes 104, 106 from rising beyond the closed position.

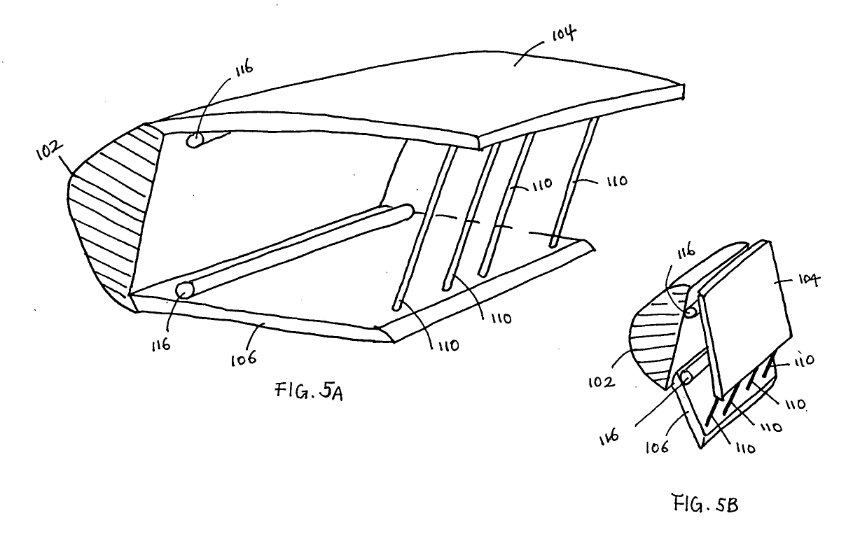

Turning to FIGS. 5A-B, a set of upper and lower vanes 104, 106 hinged at the front side of vanes 104, 106 along leading edge 102 is illustrated in accordance with some embodiments of the present invention. FIG. 5A illustrates vanes 104, 106 when they are closed. The rear side of vanes 104, 106 is hinged to one another via connecting rods 110. FIG. 5B illustrates vanes 104, 106 when vanes 104, 106 are open. Those skilled in the art will appreciate that any number of rods, such as connecting rods 110, may be used to couple vanes 104, 106.

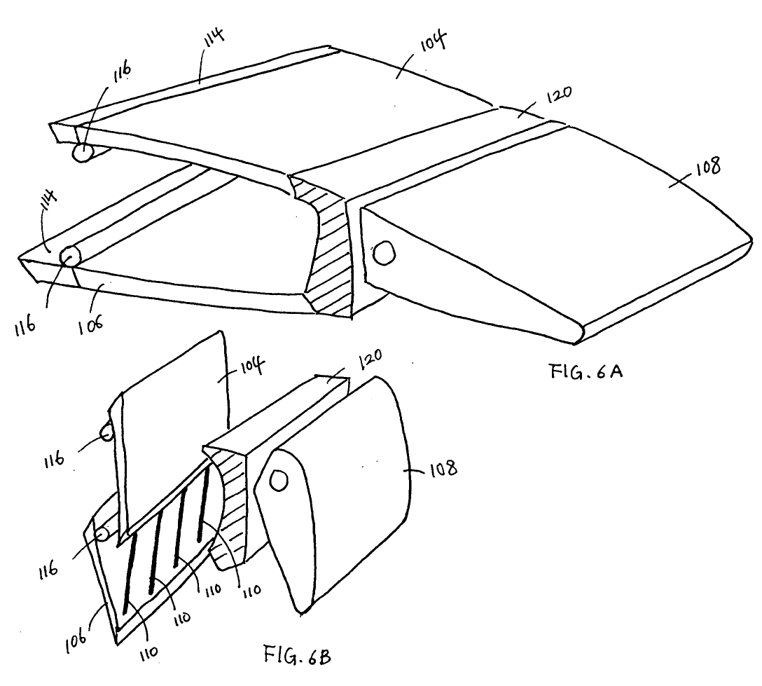

Turning to FIGS. 6A-B, a set of upper and lower vanes 104, 106 hinged at the front side of vanes 104, 106 to rib 114 near movable flap 108 is illustrated in accordance with some embodiments of the present invention. FIG. 6A illustrates vanes 104, 106 when they are closed. Movable flap 108 is hinged along a rear spar 120. FIG. 6B illustrates vanes 104, 106 when they are open; the figure also illustrates movable flap 108 when it is lowered.

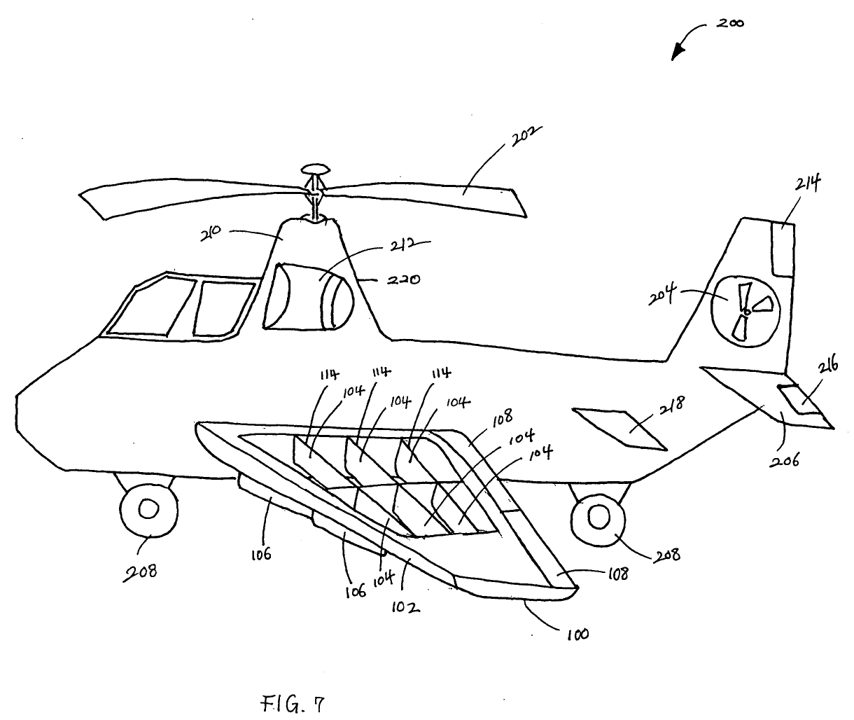

With reference to FIG. 7, an aircraft 200 having a wing, such as wing 100, is illustrated in accordance with some embodiments of the present invention. Aircraft 200 has reconfigurable wing 100, at least one rotor 202, a tail rotor 204, a tail wing 206, landing wheels 208, an engine 210, a turbofan engine 212, a rudder 214, elevators 216, auxiliary wings 218, and a rotor hub 220. Wing 100 has leading edge 102, movable flaps 108, and sets of upper vanes 104 and lower vanes 106 that are hinged along ribs 114.

Aircraft 200 can take off like a helicopter using rotor thrust that is washed downward through wing 100. In some embodiments, vanes 104, 106 are open, as shown in FIG. 2, when aircraft 200 is at rest. In some embodiments, vanes 104, 106 can be forced to open by rotor thrust. In some embodiments, vanes 104, 106 may be forced to open by gravity when aircraft 200 reaches certain airspeeds, such as stall speeds. In some embodiments, vanes 104, 106 are locked once they are closed until the pilot releases them; otherwise, it may be possible that vanes 104, 106 may inadvertently open during a flight if aircraft 200 encounters a sudden disruption, such as an air pocket. When aircraft 200 reaches certain altitudes, the pilot then may tilt rotor 202 slightly forward and accelerate as with a helicopter.

When aircraft 200 reaches certain airspeeds, air pressure generated by the forward movement of aircraft 200 can help vanes 104, 106 move to the closed position, as shown in FIG. 4C. In some embodiments, vanes 104, 106 may naturally move to their closed position gradually. In some embodiments, the pilot may cause aircraft 200 to go nose-up slightly, which will cause lower air pressure on upper vanes 104 and higher pressure on lower vanes 106, to cause vanes 104, 106 to close completely.

In some embodiments, a hydraulic mechanism may be used instead, or in addition, to close vanes 104, 106. In some other embodiments, an electromechanical mechanism may be used instead, or in addition, to close vanes 104, 106. In yet some other embodiments, a combination of a hydraulic and an electromechanical mechanism may be used to close vanes 104, 1006. Mechanisms, such as various hydraulic and electromechanical mechanisms, that are used to control moving parts of aircraft 200 are well-known to those of ordinary skill in the art.

Wing 100, when vanes 104, 106 are closed, then can function like a fixed airplane wing, thereby increasing the maximum cruising speed of aircraft 200; this is possible because vertical lift will be provided by wing 100. In some embodiments, aircraft 200 may have two rotor hubs, one in front and one in back, such as the Chinook helicopter; wing 100 in such embodiments can allow both rotors to tilt much further forwards to improve its maximum cruising speed.

The reverse process can occur when aircraft 200 lands. As the pilot slows aircraft 200 down to a helicopter-safe speed, the rotor thrust, gravity, and/or electrical or mechanical systems can force vanes 104, 106 to re-open. The pilot then gradually reduces the rotor thrust to land.

In some embodiments, turbofan engine 212 may be geared to rotor hub 220 such that aircraft 200 may include both rotor 202 for taking off or landing aircraft 200 and a mechanism for propelling aircraft 200 forward. In some of the embodiments, power is transferred from turbofan engine 212 to main rotor 202. In some of the embodiments, the pilot may be able to stop rotor 202 altogether and stow or otherwise tuck it away to reduce drag force once aircraft 200 gains enough forward thrust from turbofan engine 212.

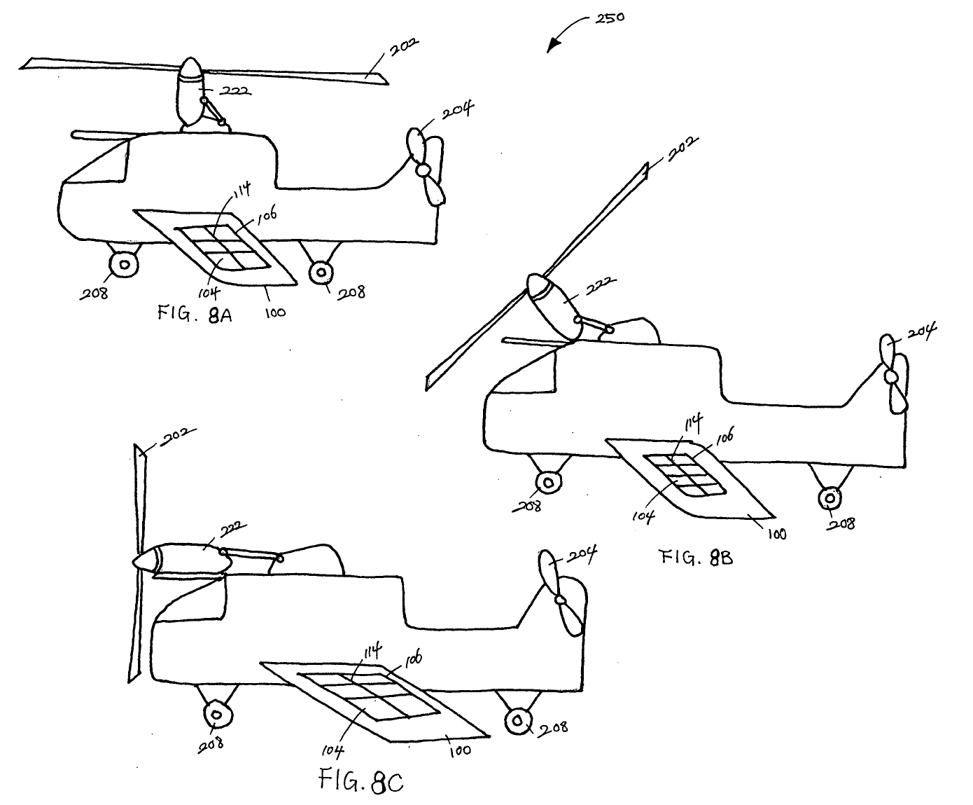

FIGS. 8A-C illustrate a hybrid aircraft 250 having a reconfigurable wing, such as wing 100, that can change the position of its main rotor 202. Hybrid aircraft 250 can take off like a helicopter using rotor thrust that is washed downward through wing 100, as shown in FIG. 8A. When aircraft 250 reaches certain altitudes, the pilot may tilt main rotor 202 slightly forward, as shown in FIG. 8B, and accelerate. The forward movement of aircraft 250 and/or electrical or mechanical systems then cause vanes 104, 106 to close in order to enable wing 100 to function as a fixed airplane wing. When vanes 104, 106 are closed, the pilot may be able to gradually tilt rotor 202 to the front of aircraft 250 to generate substantial forward thrust. Aircraft 250 is now in the airplane mode. In some embodiments, a specially designed engine 222 such as that shown in U.S. Pat. No. 6,974,105 B2, which is hereby incorporated by reference herein in its entirety, may be used. Engine 222 may, in some of the embodiments, be fitted with counter rotating rotors, such as that in the Kamov Ka-32 Russian helicopter, in which case tail rotor 204 may be omitted. The pilot can now tilt rotor 202 all the way forward to the front of aircraft 250, as shown in FIG. 8C, and accelerate to cruising speeds that are commensurate with speeds attained by the airplane with a fixed wing.

The reverse process can occur when aircraft 250 lands. The pilot reduces the airspeed of aircraft 250 and brings up rotor 202 gradually until rotor's 202 downward thrust, gravity, and/or electrical or mechanical systems force vanes 104, 106 to re-open. Aircraft 250 is now in the helicopter mode and the pilot can slow aircraft 250 down and land it. Advantageously, aircraft 250 can land either in the helicopter mode or in the airplane mode, thereby aircraft 250 will be safe; even if aircraft 250 fails to make the transition from the airplane mode back to the helicopter mode due to a malfunction, for instance, aircraft 250 can still land like the airplane.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. The disclosed subject matter can be used to prevent attacks in addition to the illustrative example attacks described above. It should be noted that features of the disclosed embodiments can be combined and rearranged in various ways.

What is claimed is:

1. An aircraft wing comprising at least one set of hinged upper and lower vanes that allows downward thrust to go through the wing when the vanes-are open and provides normal lift of a fixed wing when the vanes are closed.

2. The aircraft wing of claim 1, further comprising at least one rod that is used to couple the rear side of the upper and lower vanes.

3. The aircraft wing of claim 2, further comprising at least one tab that is coupled to the lower vane, wherein the at least one tab causes the vanes to move aft and up to a closed position when a level of air pressure is applied to the tab.

4. The aircraft wing of claim 1, further comprising a hydraulic mechanism that is used to open and close the vanes.

5. The aircraft wing of claim 1, further comprising an electromechanical mechanism that is used to open and close the vanes.

6. The aircraft wing of claim 1, wherein the at least one set of hinged upper and lower vanes are hinged along leading edges and between ribs of the wing.

7. The aircraft wing of claim 1, wherein the at least one set of hinged upper and lower vanes are hinged at their front side to a rib of the wing.

8. An aircraft comprising:
a propulsion mechanism; and
a wing having at least one set of hinged upper and lower vanes.

9. The aircraft of claim 8, wherein the propulsion mechanism comprises an engine with at least one rotor that can be positioned substantially on top of the aircraft and facing the front of the aircraft.

10. The aircraft of claim 9, wherein the at least one rotor comprises counter-rotating rotors.

11. The aircraft of claim 9, wherein the at least one rotor is configured to relocate to the front of the aircraft.

12. The aircraft of claim 9, wherein the propulsion mechanism further comprises a turbofan engine that is geared to the rotor hub of the aircraft.

13. The aircraft of claim 12, wherein the at least one rotor is deactivated and tucked away when the turbofan engine provides forward propulsion and the at least one set of hinged vanes are closed.

14. The aircraft of claim 8, wherein the aircraft comprises two rotor hubs.

15. The aircraft of claim 8, wherein the at least one set of hinged upper and lower vanes is configured to open when the aircraft vertically takes off using downward thrust generated by the propulsion mechanism located above the wing.

16. The aircraft of claim 8, wherein the at least one set of hinged upper and lower vanes is configured to close when the wing is subjected to air pressure created by forward movement of the aircraft.

17. The aircraft of claim 8, wherein the at least one set of hinged upper and lower vanes are hinged to a spar of the wing in front of the vanes.

18. The aircraft of claim 8, wherein the rear side of the upper vane and the lower vane is hinged to one another via at least one rod.

19. The aircraft of claim 8, further comprising at least one tab that is coupled to the rear side of the lower vane, wherein the at least one tab causes the upper and lower vanes to move aft and up to a closed position when a level of air pressure is applied to the tab.

20. The aircraft of claim 8, wherein the at least one set of upper and lower vanes opens and closes using one or more of a hydraulic mechanism and an electromechanical mechanism.
